(19) United States
(12) Patent Application Publication
(10) Pub. No.: US 2009/0268784 A1
(43) Pub. Date: Oct. 29, 2009

(54) MULTI-BAND OFDM RECEIVER

(75) Inventors: Kenneth A. Boehlke, Portland, OR (US); James N. Svoboda, Beaverton, OR (US); Liang Xian, Hillsboro, OR (US)

Correspondence Address: SMITH-HILL AND BEDELL, P.C., 16100 NW CORNELL ROAD, SUITE 220, BEAVERTON, OR, 97006, US

(73) Assignee: FOCUS ENHANCEMENTS, INC., Campbell, CA (US)

(21) Appl. No.: 12/171,767

(22) Filed: Jul. 11, 2008

Related U.S. Application Data
(60) Provisional application No. 60/949,300, filed on Jul. 12, 2007.

(51) Int. Cl. H04B 1/713; H04B 1/69

(52) U.S. Cl. 375/133; 375/136; 375/260; 375/E01.033

(57) ABSTRACT

A wireless communication arrangement includes a transmitter that transmits a signal having a carrier that repeatedly and sequentially hops through a first sequence of frequencies. A receiver includes a mixer having an antenna signal input for receiving an antenna signal, and a local oscillator for generating a local oscillator signal and providing the local oscillator signal to a local oscillator input of the mixer. The local oscillator signal repeatedly and sequentially hops through a second sequence of frequencies having fewer members than the first sequence of frequencies and the repetition frequency with which the local oscillator signal hops through the second sequence of frequencies is substantially equal to the repetition frequency with which the carrier hops through the first sequence of frequencies. Preferably, the receiver includes an ADC that is sampled at a rate greater than twice the bandwidth of the antenna signal.

### CROSS-REFERENCE TO RELATED APPLICATION

This application claims benefit of U.S. Provisional Application No. 60/949,300 filed Jul. 12, 2007, the entire disclosure of which is hereby incorporated herein by reference for all purposes.

### BACKGROUND OF THE INVENTION

The subject matter disclosed in this application relates to a multi-band OFDM receiver.

The WiMedia Alliance has been established to promote wireless multimedia connectivity and interoperability between devices in a personal area network. As part of this mission, the WiMedia Alliance has specified a multi-band OFDM (Orthogonal Frequency Division Multiplexing) radio transmitter that transmits a bit stream at 320 Mbps, 400 Mbps or 480 Mbps using a frequency spreading scheme by which the spectrum from 3.168 GHz to 10.560 GHz is divided into 14 bands each 528 MHz wide and having center frequencies at 3.432 GHz, 3.96 GHz, etc. up to 10.296 GHz. Bands 1-12, having center frequencies from 3.432 GHz to 9.240 GHz are allocated to four band groups, each containing three bands, whereas bands 13 and 14 are allocated to a band group containing just two bands. The carrier hops through the bands sequentially and repeatedly, remaining in each band for an interval of 312.5 ns. Within each band, the carrier is modulated by 100 subcarriers or tones that are sufficiently spaced in frequency to be orthogonal. Each tone has two components in quadrature (I, J) and the two components are modulated in amplitude by four consecutive bits of the incoming bit stream in accordance with a 16-ary quadrature amplitude modulation (16QAM) scheme. Two hundred consecutive bits (50 sets of four consecutive bits) modulate both the 50 lower tones in each band and the 50 higher tones, so that tone k+50 (k=1-50) conveys the same information as tone k. The transmitter is also able to transmit at lower data rates (for example, 200 Mbps, in which case the two components of each tone are modulated in amplitude by two consecutive bits of the bit stream employing QPSK modulation.

In principle, the receiver (FIG. 1) may recover the signal information from the antenna signal using a mixer 10 that receives a local oscillator signal that hops synchronously with the frequency hopping of the transmitter to downconvert the antenna signal to an intermediate frequency, a low pass filter 11 to remove spurious modulation products, and an analog-to-digital converter 12 for sampling the signal at 1.056 GHz and generating a baseband bitstream. A baseband digital signal processing block 13 recovers the data and provides a control signal that is used to synchronize operation of the local oscillator 14. Although the arrangement shown in FIG. 1 is functional, the need to hop the receiver's local oscillator signal synchronously with the transmitter's carrier contributes significant complexity to the RF receiver design.

### SUMMARY OF THE INVENTION

According to a first aspect of the disclosed subject matter there is provided a wireless communication arrangement comprising a transmitter that transmits a signal having a carrier that repeatedly and sequentially hops through a first sequence of frequencies, and a receiver including a mixer having an antenna signal input for receiving an antenna signal, and a local oscillator for generating a local oscillator signal and providing the local oscillator signal to a local oscillator input of the mixer, wherein the local oscillator signal repeatedly and sequentially hops through a second sequence of frequencies having fewer members than the first sequence of frequencies and the repetition frequency with which the local oscillator signal hops through the second sequence of frequencies is substantially equal to the repetition frequency with which the carrier hops through the first sequence of frequencies.

According to a second aspect of the disclosed subject matter there is provided a method of operating a wireless transmitter and receiver comprising employing the transmitter to transmit a signal having a carrier that repeatedly and sequentially hops through a first sequence of frequencies, and employing the receiver to mix a received antenna signal with a local oscillator signal that repeatedly and sequentially hops through a second sequence of frequencies having fewer members than the first sequence of frequencies, and wherein the repetition frequency with which the local oscillator signal hops through the second sequence of frequencies is substantially equal to the repetition frequency with which the carrier hops through the first sequence of frequencies.

### BRIEF DESCRIPTION OF THE DRAWINGS

For a better understanding of the invention, and to show how the same may be carried into effect, reference will now be made, by way of example, to the accompanying drawings, in which:

FIG. 1 is a schematic block diagram of a receiver suitable for receiving the WiMedia multi-band OFDM signal,

FIG. 2 is a schematic block diagram of a receiver embodying the subject matter disclosed in this application,

FIG. 3 is a graph illustrating waveforms that are used in explaining operation of the receiver shown in FIG. 2,

FIG. 4 is a schematic block diagram of a second receiver embodying the subject matter disclosed in this application,

FIG. 5 is a graph illustrating waveforms that are used in explaining operation of the receiver shown in FIG. 4,

FIG. 6 is a schematic block diagram of a third receiver embodying the subject matter disclosed in this application, and

FIG. 7 is a graph illustrating waveforms that are used in explaining operation of the receiver shown in FIG. 6.

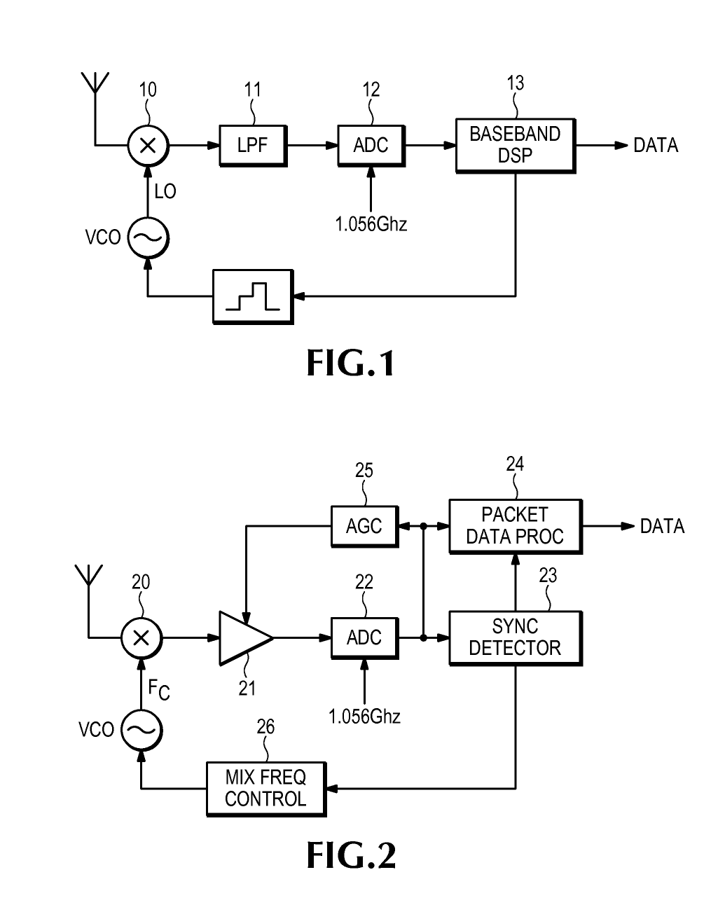

### DETAILED DESCRIPTION

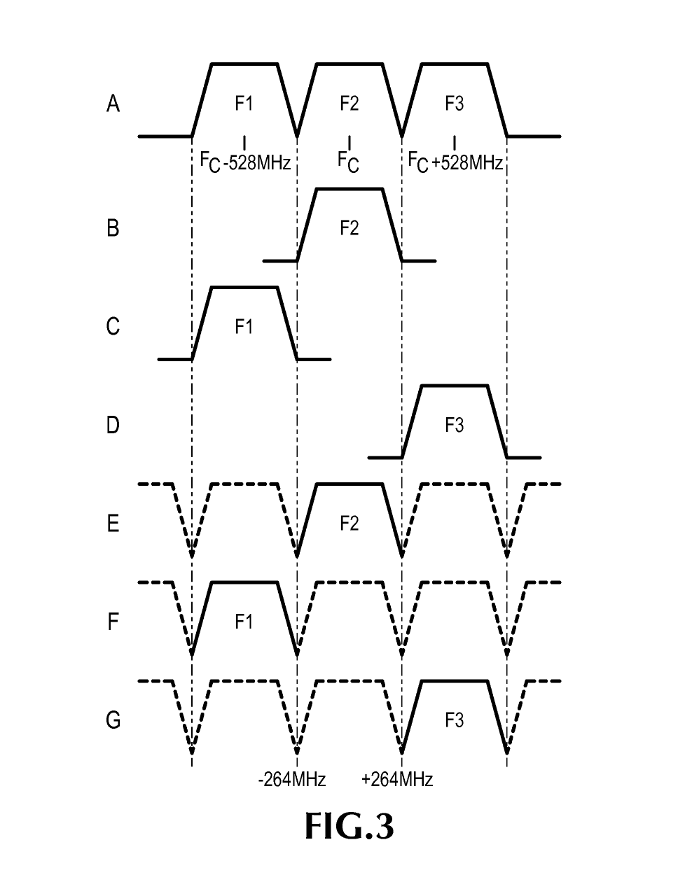

Referring to FIGS. 2 and 3, during each of the four lower band groups, for which the center frequency of the middle band (F2) is Fc and the center frequencies of the lower and upper bands (F1 and F3) are Fc−528 MHz and Fc+528 MHz respectively as shown by waveform A in FIG. 3, the local oscillator signal remains at the frequency Fc rather than hopping with the center frequency of the individual bands.

Considering first the band F2, having a frequency range from Fc−264 MHz to Fc+264 MHz, mixing with the local oscillator signal at Fc translates the antenna signal to the range from −264 MHz to +264 MHz as shown by waveform B in FIG. 3. Referring to FIG. 2, the analog output signal of the mixer 20 is amplified by a controllable gain element 21 and is supplied to the ADC 22. The bandwidth of the signal (528 MHz) is such that the signal can be digitized by the ADC using a sampling clock at 1.056 GHz.

When the analog mixer output signal is converted to digital form by the ADC 12, by sampling at 1.056 GHz and quantizing the samples, the spectrum of the analog signal is replicated in the digital domain at intervals of 528 MHz as indicated by the dashed line portions of the waveform E in FIG. 3.

The mixer translates the band F1, having a frequency range from Fc−792 MHz to Fc−264 MHz, to the range from −792 MHz to −264 MHz and the bandwidth of the signal is still 528 MHz (waveform C). By digitizing the analog mixer output signal, the ADC replicates the spectrum of the analog signal in the digital domain at intervals of 528 MHz. Thus, the ADC replicates the spectrum in the band from −792 to −264 MHz in the band from −264 MHz to +264 MHz as shown by the dashed line portions of waveform F. Similarly, the mixer also translates the band F3, having a frequency range from Fc+792 MHz to Fc+264 MHz, to the range from +264 MHz to +792 MHz (waveform D) and the ADC replicates the spectrum in the band from +264 MHz to +792 MHz in the band from −264 MHz to +264 MHz (waveform G).

By employing a local oscillator signal at Fc for all three bands and sampling at 1.056 GHz, signal power for all three bands is in the analysis range from −264 MHz to +264 MHz and can be processed by the digital portion of the receiver.

The output signal of the ADC 22 is a bit stream at 1.056 Gb/s and is supplied to a sync detector 23, which monitors the bit stream for a sync sequence, and to a packet data processor 24, which recovers payload data packets from the bit stream when the sync detector identifies the sync sequence. In addition, the output signal of the ADC is supplied to an automatic gain control circuit 25 for controlling the gain element 21 in order to normalize the signal amplitude.

The sync detector 23 supplies a control signal to a mix frequency controller 26, which controls the frequency of the local oscillator signal so that the frequency of the local oscillator signal matches the center frequency of the middle band in the current band group (containing three bands) or another suitable frequency in the event that the current band group contains a different number of bands.

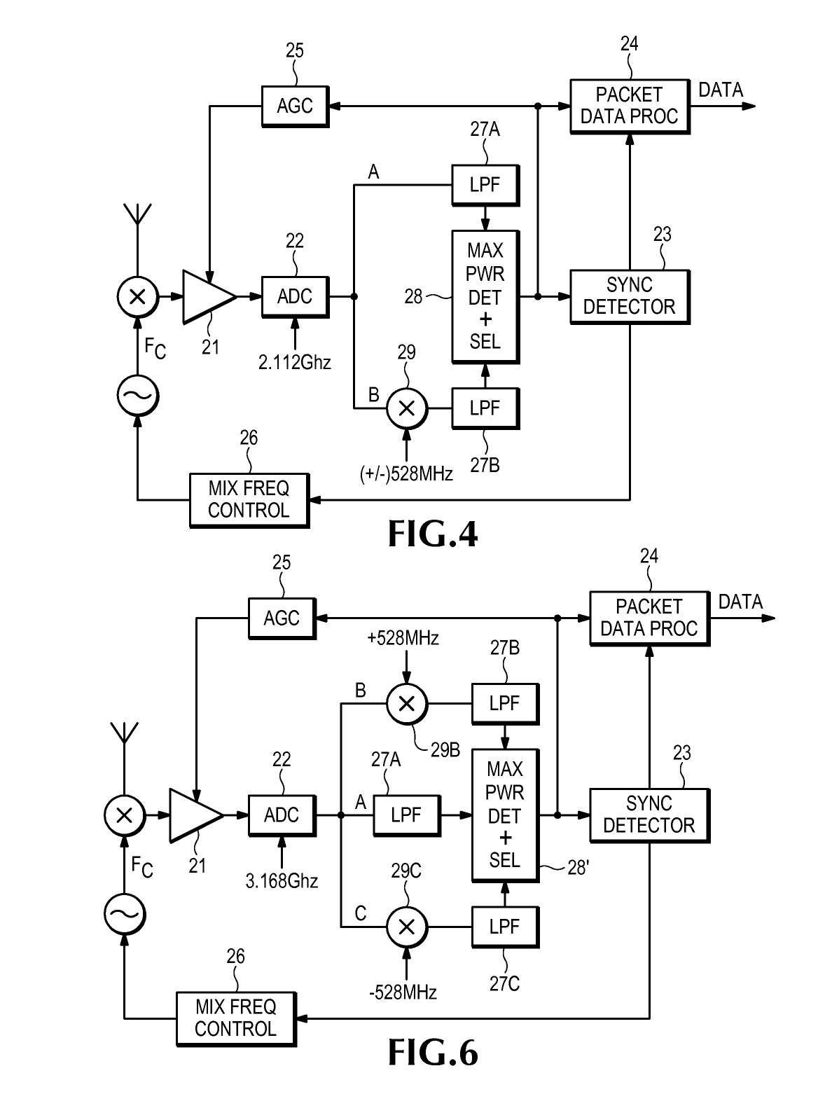

FIG. 4 illustrates a development of the receiver shown in FIG. 2. In the case of the receiver shown in FIG. 4, the ADC 22 oversamples the amplified mixer signal by sampling at twice the Nyquist rate (i.e. at 2.112 GHz).

The ADC's sampling rate of 2.112 GHz corresponds to 1.056 MHz complex, which may be considered to be −1.056 GHz and +1.056 GHz, having corresponding Nyquist frequencies of −528 MHz and +528 MHz.

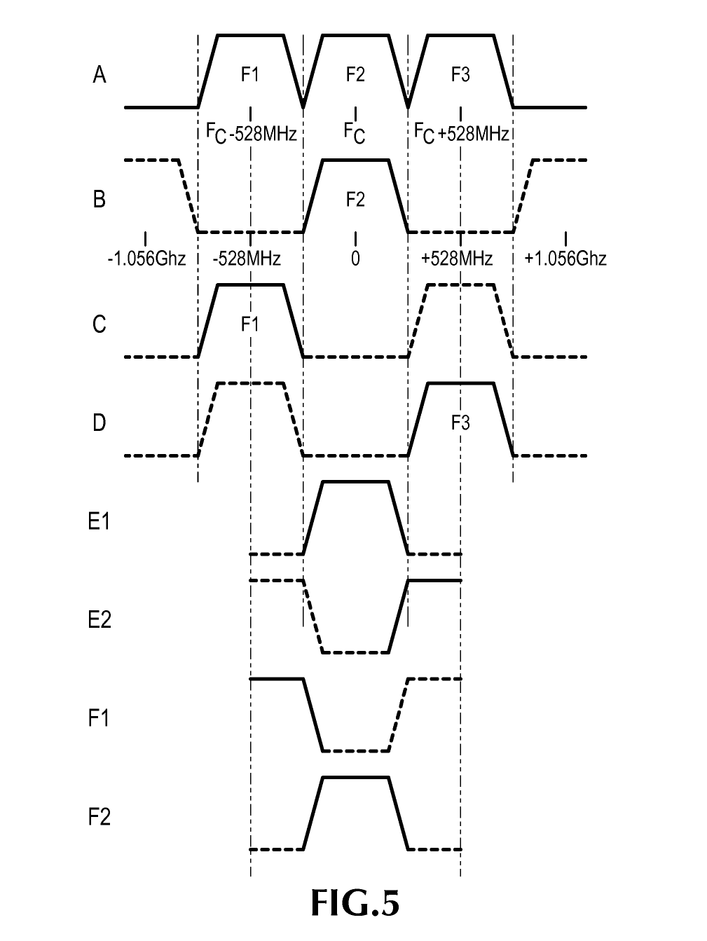

Referring to both FIG. 4 and FIG. 5, and considering first the band F2, sampling at +1.056 GHz detects signal power in the band from 0 (DC) to +528 MHz and sampling at −1.056 GHz detects signal power in the band from −528 MHz to 0. By digitizing the analog mixer output signal using a sampling clock at 1.056 GHz complex, the ADC replicates the spectrum of the analog signal at intervals of 1.056 GHz, as shown by the dashed line portions of waveform B in FIG. 5. Similarly, considering the bands F1 and F3, the ADC replicates the spectra of the analog signals at intervals of 1.056 GHz (waveforms C and D). Consequently, the frequency ranges from −528 MHz to −264 MHz and from +264 MHz to +528 MHz contain signal power from both band F1 and band F3.

Referring to FIG. 4, the output signal of the ADC is split into two paths A and B. The signal on path A is supplied via a digital low pass filter 27A having a cutoff frequency of 528 MHz to one input of a maximum power detector 28. The signal on path B is translated by +528 MHz by a mixer 29 and the output signal of the mixer is supplied to a digital low pass filter 27B having a cutoff frequency of 528 MHz. The output of the low pass filter 27B is supplied to a second input of the maximum power detector 28.

If the receiver is currently processing band F2, the signal received by the maximum power detector on path A contains signal power over the range from −264 MHz to +264 MHz (waveform E1) and the signal received on path B contains signal power over the range from 0 to +528 MHz (waveform E2). However, the range from +264 MHz to +528 MHz is outside the analysis range of the maximum power detector and consequently the maximum power detector interprets the signal on path A as having greater signal power than that on path B.

If the receiver is currently processing band F1 or F2, the signal received by the maximum power detector on path A contains signal power over the range from −528 MHz to −264 MHz and from +264 MHz to +528 MHz (waveform F1) and the signal received on path B contains signal power over the range from −264 MHz to +264 MHz (waveform F2). However, the ranges from −528 MHz to −264 MHz and from +264 MHz to +528 MHz are outside the analysis range of the maximum power detector and consequently the maximum power detector interprets the signal on path B as having greater power than that on path A.

Based on whether the signal on path A or on path B has greater signal power, the maximum power detector is able to distinguish between band F2 and bands F1 and F3, and detect the transitions from band F1 to band F2 and from band F2 to band F3. In this manner, the maximum power detector is able to keep track of the hopping by the transmitter.

The maximum power detector selects the signal of greater power and supplies that signal to the sync detection block, the packet data processor and the automatic gain control circuit.

FIG. 6 illustrates a development of the receiver shown in FIG. 4. In the case of FIG. 6, the ADC samples the output signal of the gain element at 3.168 GHz (corresponding to 1.584 GHz complex), having Nyquist frequencies of −792 MHz and +792 MHz.

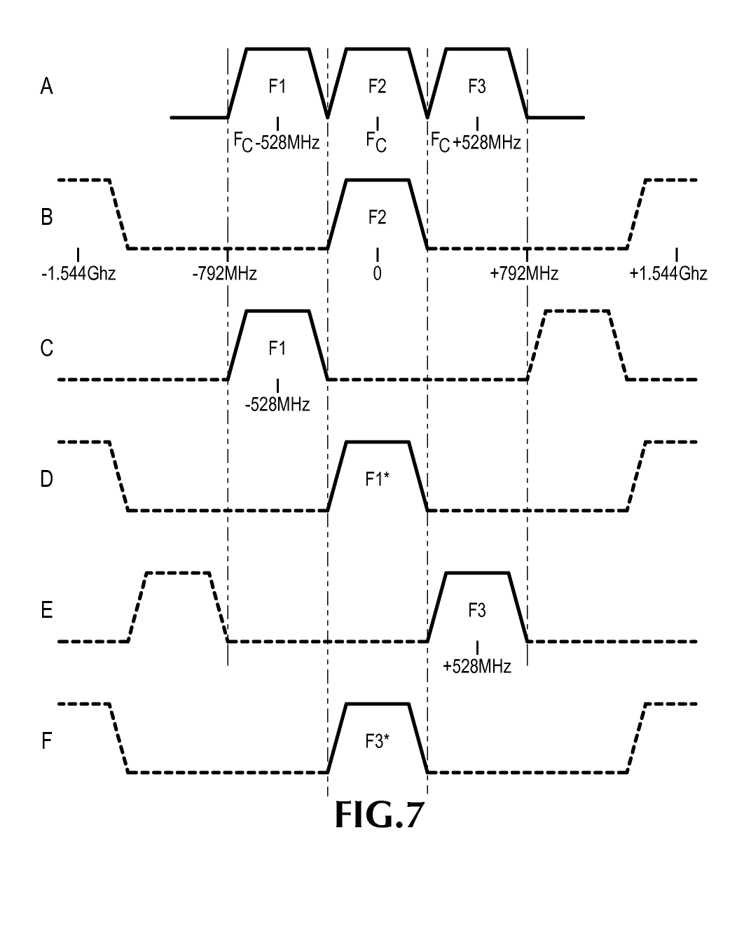

Referring to both FIG. 4 and FIG. 6, and considering first the band F2, sampling at +1.584 GHz detects signal power in the band from 0 to +792 MHz and sampling at −1.584 GHz detects signal power in the band from −792 MHz to 0. By digitizing the analog mixer output signal using a sampling clock at 1.584 GHz complex, the ADC replicates the spectrum of the analog signal at intervals of 1.584 GHz, as shown by the dashed line portions of the waveform B in FIG. 7. Similarly, considering the bands F1 and F3, the ADC replicates the spectra of the analog signals at intervals of 1.584 GHz (waveforms C and D).

Referring to FIG. 6, the output signal of the ADC is split into three paths A, B and C. The signal on path A is supplied via the digital low pass filter 27A having a cutoff frequency of 528 MHz to one input of the maximum power detector 28. The signal on path B is translated by +528 MHz by a mixer 29B and the output signal of the mixer is supplied to a digital low pass filter 27B having a cutoff frequency of 528 MHz. The output of the low pass filter 27B is supplied to a second input of the maximum power detector 28. The signal on path C is translated by −528 MHz by a mixer 29C and supplied via a digital low pass filter 27C to a third input of the maximum power detector 28.

If the receiver is currently processing band F2, the signal received by the maximum power detector on path A contains signal power over the range from −264 MHz to +264 MHz and the signal received on paths B and C contains no signal power. If the receiver is currently processing band F1, the signal received by the maximum power detector on path A contains no signal power, the signal received on path B contains signal power over the range from −264 MHz to +264 MHz (waveform D, where the asterisk indicates frequency translation) and the signal received on path C contains no signal power. Similarly, if the receiver is currently processing band F3, the signal received by the maximum power detector on path A contains no signal power, the signal received on path B contains no signal power and the signal received on path C contains signal power over the range from −264 MHz to +264 MHz (waveform F). Thus, the maximum power detector 28 is able to determine, based on which path currently provides the signal of maximum power, whether band F1, F2 or F3 is currently being received. The maximum power detector selects the signal having the maximum power and directs that signal to the AGC, sync detector and packet data processor.

It can be shown that in the case of sampling at 1.056 GHz, the noise level is three times that of single band, whereas with sampling a 2.112 GHz, the noise level is 1.67 times that of a single band and when sampling at 3.168 GHz, there is no increase in noise.

A receiver having the topology shown in FIG. 6 may employ an ADC that is sampled at 4.224 GHZ. In this case, the transition bands are outside the hopping bands due to additional oversampling.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A wireless communication arrangement comprising:
a transmitter that transmits a signal having a carrier that repeatedly and sequentially hops through a first sequence of frequencies, and
a receiver including a mixer having an antenna signal input for receiving an antenna signal, and a local oscillator for generating a local oscillator signal and providing the local oscillator signal to a local oscillator input of the mixer, wherein the local oscillator signal repeatedly and sequentially hops through a second sequence of frequencies having fewer members than the first sequence of frequencies and the repetition frequency with which the local oscillator signal hops through the second sequence of frequencies is substantially equal to the repetition frequency with which the carrier hops through the first sequence of frequencies.

2. A wireless communication arrangement according to claim 1, wherein the receiver includes an ADC that is sampled at a rate greater than twice the bandwidth of the antenna signal.

3. A wireless communication arrangement according to claim 2, wherein the ADC is sampled at a rate that is substantially equal to four times the bandwidth of the antenna signal.

4. A wireless communication arrangement according to claim 2, wherein the ADC is sampled at a rate that is substantially equal to six times the bandwidth of the antenna signal.

5. A wireless communication arrangement according to claim 2, including a processing network connected to an output of the ADC and having at least two processing paths, and a maximum power detector connected to the processing paths of the processing network for distinguishing between a transmitter signal component having a carrier frequency equal to a frequency of the second sequence and a transmitter signal component having a carrier frequency different from a frequency of the second sequence.

6. A wireless communication arrangement according to claim 1, wherein the first sequence of frequencies includes first, second and third frequencies, with the first and third frequency different from each other and the second frequency equal to the mean of the first and third frequencies, and the second sequence of frequencies includes a frequency equal to the second frequency.

7. A method of operating a wireless transmitter and receiver comprising:
employing the transmitter to transmit a signal having a carrier that repeatedly and sequentially hops through a first sequence of frequencies, and
employing the receiver to mix a received antenna signal with a local oscillator signal that repeatedly and sequentially hops through a second sequence of frequencies having fewer members than the first sequence of frequencies,
and wherein the repetition frequency with which the local oscillator signal hops through the second sequence of frequencies is substantially equal to the repetition frequency with which the carrier hops through the first sequence of frequencies.

8. A method according to claim 7, wherein mixing the received antenna signal with the local oscillator signal produces a mixer output signal and the method comprises converting the mixer output signal to digital form by sampling the mixer output signal at a rate greater than twice the bandwidth of the received antenna signal and quantizing the samples.

9. A method according to claim 8, comprising sampling the mixer output signal at a rate that is substantially equal to four times the bandwidth of the antenna signal.

10. A method according to claim 8, comprising sampling the mixer output signal at a rate that is substantially equal to six times the bandwidth of the antenna signal.

11. A method according to claim 8, comprising processing the quantized samples using at least two procedures and comparing the respective results of the procedures, and wherein the procedures distinguish between a transmitter signal component having a carrier frequency equal to a frequency of the second sequence and a transmitter signal component having a carrier frequency different from a frequency of the second sequence.

12. A method according to claim 7, wherein the first sequence of frequencies includes first, second and third frequencies, with the first and third frequency different from each other and the second frequency equal to the mean of the first and third frequencies, and the second sequence of frequencies includes a frequency equal to the second frequency.
